(19) United States
(12) Patent Application Publication
(10) Pub. No.: US 2007/0004856 A1
(43) Pub. Date: Jan. 4, 2007

(54) Self-crosslinking polyurethane dispersions and a process for their preparation

(75) Inventors: Jan Mazanek, Koln (DE); Dorota Greszta-Franz, Erkrath (DE); Sebastian Dorr, Dusseldorf (DE); Jurgen Meixner, Krefeld (DE); Reinhard Halpaap, Odenthal (DE); Helmut Muller, Leverkusen (DE); Olaf Fleck, Bergisch Gladbach (DE); Heino Muller, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/475,691

(22) Filed: Jun. 27, 2006

(30) Foreign Application Priority Data
Jun. 29, 2005 (DE) 102005030225.4

(51) Int. Cl. C08G 18/08

(52) U.S. Cl. 524/589

(57) ABSTRACT

The present invention relates to a process for preparing self-crosslinking polyurethane dispersions by I) reacting a1) polyisocyanates with a2) at least one hydroxyl component having an average OH functionality of ≧2 and a number average molecular weight of 62 to 2500 g/mol, wherein the hydroxyl component contains at least one acid-functional compound containing at least one isocyanate-reactive group, to form an NCO-functional and optionally OH-functional prepolymer, II) then reacting the NCO-functional and optionally OH-functional prepolymer with a3) a hydroxyl component having an average OH functionality of >1 and a4) optionally another polyisocyanate component, which may be the same as or different from a1), to form an OH-functional and NCO-free polyurethane, III) adding a blocked polyisocyanate either before, during or after the reaction of steps I) and II), or forming a blocked polyisocyanate in situ from a polyisocyanate and a blocking agent after the reaction of step II) has taken place, IV) neutralizing the acid groups of the resulting composition by adding a5) a neutralizing agent, and V) dispersing the resulting composition in water. The present invention also relates to the dispersions prepared by the present invention and to their use in coating, adhesive and sealant compositions.

### BACKGROUND OF THE INVENTION

1. Field of the Invention

The present invention relates to a process for preparing self-crosslinking polyurethane dispersions, to the resulting dispersions and to their use in coating, adhesive or sealant compositions.

2. Description of Related Art

Recent years have seen a sharp rise in the profile of aqueous coating compositions in the wake of increasingly stringent emissions directives governing the solvents released during paint application. Although for many fields of application there are now aqueous coating systems available, these systems are often unable to attain the high quality level of conventional, solvent-borne coating compositions with respect to solvent resistance, chemical resistance, elasticity and mechanical durability. In particular, there has been no disclosure of any polyurethane-based coating compositions that can be processed from the aqueous phase and satisfy the exacting requirements of automotive OEM finishing.

The preceding statements apply both to DE-A 40 01 783, which relates to special anionically modified aliphatic polyisocyanates, and to the systems of DE-A 24 56 469, DE-A 28 14 815, EP-A 0 012 348 and EP-A 0 424 697, which describe aqueous baking enamel binders based on blocked polyisocyanates and organic polyhydroxyl compounds. Additionally, the systems based on carboxyl-containing polyurethane prepolymers with blocked isocyanate groups from DE-A 27 08 611, or the blocked water soluble urethane prepolymers from DE-A 32 34 590, which have a high functionality and thus are largely unsuitable for producing elastic, flexible coatings, are to a large extent not useful for the stated purpose.

Further improvements have been made in recent years to one-component (1K) baking enamels, e.g. as in EP-A 0 576 952, in which combinations of water soluble or water dispersible polyhydroxy compounds with water soluble or water dispersible blocked polyisocyanates are described, or in DE-A 199 30 555, which discloses combinations of a water dispersible, hydroxy-functional binder component containing urethane groups, a binder component which contains blocked isocyanate groups and is prepared in a multi-stage process over two prepolymerization steps, an amino resin and other components. EP-A 0 427 028 describes water dispersible binder compositions which serve as baking surfacers and contain a dispersion of a urethane-modified polyester resin containing carboxylate groups and an amino resin and/or blocked polyisocyanate, which is added to this dispersion, and optionally an emulsifier. Blocking agents specified for the polyisocyanate are alcohols, phenols, lactams and oximes. A disadvantage of these one-component systems is that the components prepared in advance are then formulated to coating compositions, which necessitates an additional mixing step.

U.S. application WO 02/14395 describes self-crosslinking polyurethane dispersions containing polyols which have urethane groups and hydroxyl groups and are prepared by the statistical incorporation of hydrophilic agents, and non-hydrophilic polyisocyanates blocked at least 50 equivalent per cent with dimethylpyrazole derivatives.

The coating compositions described in the prior art do not meet all of the requirements of practitioners, particularly the solids content.

It is an object of the present invention to provide improved 1K baking systems, in which the coating compositions have a high solids content and the resulting coatings exhibit good solvent resistance.

This object may be achieved with the process of the present invention for preparing self-crosslinking polyurethane dispersions having an improved solids content, which can be cured to provide coatings distinguished by good solvent resistance.

### SUMMARY OF THE INVENTION

The present invention relates to a process for preparing self-crosslinking polyurethane dispersions by

I) reacting
a1) polyisocyanates with
a2) at least one hydroxyl component having an average OH functionality of ≧2 and a number average molecular weight of 62 to 2500 g/mol, wherein the hydroxyl component contains at least one acid-functional compound containing at least one isocyanate-reactive group,
to form an NCO-functional or optionally OH-functional prepolymer,

II) then reacting the NCO-functional or optionally OH-functional prepolymer with
a3) a hydroxyl component having an average OH functionality of >1 and
a4) optionally another polyisocyanate component, which may be the same as or different from a1),
to form an OH-functional and NCO-free polyurethane,

III) adding a blocked polyisocyanate either before, during or after the reaction of steps I) and II), or forming a blocked polyisocyanate in situ from a polyisocyanate and a blocking agent after the reaction of step II) has taken place,

IV) neutralizing the acid groups of the resulting composition by adding
a5) a neutralizing agent, and

V) dispersing the resulting composition in water.

The present invention also relates to the dispersions prepared by the present invention and to their use in coating, adhesive and sealant compositions.

### DETAILED DESCRIPTION OF THE INVENTION

In the process of the invention the equivalent ratio of isocyanate groups, including the blocked isocyanate groups, to all isocyanate-reactive groups is 0.5 to 5.0:1, preferably 0.6 to 2.0:1, and more preferably 0.8 to 1.5:1.

In components a1) and a4) it is possible to any of the known organic compounds containing isocyanate groups, preferably aliphatic, cycloaliphatic, aromatic or heterocyclic polyisocyanates with an NCO functionality ≧2. The isocyanate compounds may be used individually or in any desired mixtures with one another. It is unimportant whether these compounds have been prepared by phosgenation or by phosgene-free processes.

Examples of suitable isocyanates include tetramethylene diisocyanate, cyclohexane 1,3- and 1,4-diisocyanate, hexamethylene diisocyanate (HDI), 1-isocyanato-3,3,5-trimethyl-5-isocyanatomethylcyclohexane (isophorone diisocyanate IPDI), methylene-bis(4-isocyanatocyclohexane), tetramethylxylylene diisocyanate (TMXDI), triisocyanatononane, tolylene diisocyanate (TDI), diphenylmethane 2,4′- and/or 4,4′-diisocyanate (MDI), triphenylmethane 4,4′-diisocyanate, naphthylene 1,5-diisocyanate, and mixtures of these isocyanates.

Also suitable are the polyisocyanates adducts prepared from the preceding monomeric isocyanates and having uretdione, carbodiimide, isocyanurate, iminooxadiazine dione, biuret, urethane, allophanate, oxadiazinetrione or acylurea groups, and also polyisocyanate prepolymers with an average NCO functionality >1, which may be obtained by initially reacting a molar excess of one of the preceding monomeric polyisocyanates or polyisocyanate adducts with an organic compound containing at least two isocyanate-reactive groups per molecule, for example, OH groups.

In a1) or a4) it is preferred to use isocyanates having a number average molecular weight of 140 to 1000 g/mol.

Particularly preferred components a1) and/or a4) are polyisocyanates or polyisocyanate mixtures exclusively containing aliphatically or cycloaliphatically bound isocyanate groups, especially hexamethylene diisocyanate (HDI), isophorone diisocyanate (IPDI) and/or 4,4′-diisocyanatodicyclohexylmethane or polyisocyanate adducts prepared from these diisocyanates.

Hydroxyl component a2) preferably has an average OH functionality of 2 to 6 and a number average molecular weight of 62 to 2500 g/mol, preferably 62 to 1000 g/mol and more preferably 62 to 500 g/mol, and contains an acid-functional compound which in addition to the acid function also contains at least one isocyanate-reactive group such as OH, NH or SH. For the purposes of the present invention isocyanate-reactive groups, such as NH or SH groups, are calculated as OH groups when determining the average OH functionality.

Suitable compounds a2) include 1,4-butanediol, 1,3-butanediol, 1,6-hexanediol, 2,2,4-trimethyl-1,3-pentanediol, trimethylolpropane, and/or polyester polyols and polyether polyols having a number average molecular weight of ≦2000 g/mol. When polyethers are used, component a2) preferably contains more than 50 mol %, based on the total amount of component a2), of an acid-functional compound which in addition to the acid function also contains at least one isocyanate-reactive group such as OH, NH or SH.

Examples of suitable acid-functional compounds include hydroxy-functional carboxylic acids and/or sulphonic acids, preferably mono- and dihydroxycarboxylic acids, such as 2-hydroxyacetic acid, 3-hydroxypropanoic acid, 12-hydroxy-9-octadecanoic acid (ricinoleic acid), hydroxypivalic acid, lactic acid and/or dimethylolpropionic acid. Preferred are hydroxypivalic acid, lactic acid and/or dimethylolpropionic acid; dimethylolpropionic acid is especially preferred.

In a particularly preferred embodiment, component a2) exclusively contains the preceding acid-functional compounds, more preferably dimethylolpropionic acid is exclusively used as component a2).

Hydroxyl component a3) is selected from
b1) dihydric to hexahydric alcohols having number average molecular weights of 62 to 300 g/mol, preferably 62 to 182 g/mol, and more preferably 62 to 118 g/mol,
b2) polyols having an OH functionality ≧2 and having number average molecular weights of 300 to 5000 g/mol, preferably 300 to 3000 g/mol, and more preferably 300 to 2000 g/mol and/or
b3) monofunctional linear polyethers having number average molecular weights of 300 to 3000 g/mol, preferably 300 to 2000 g/mol, and more preferably 300 to 1000 g/mol.

Suitable polyols b1) include dihydric to hexahydric alcohols and/or mixtures thereof, which preferably do not contain ester groups. Examples include ethane-1,2-diol, propane-1,2- and -1,3-diol, butane-1,4- or -1,2-diol or hexane-1,6-diol, 1,4-dihydroxycyclohexane, glycerol, trimethylolethane, trimethylolpropane, pentaerythritol and sorbitol. Component b1) also includes alcohols having ionic groups or potential ionic groups. Preferred compounds b1) are 1,4- or 1,3-butanediol, 1,6-hexanediol and/or trimethylolpropane.

Suitable polyols b2) include polyethers, polyesters and/or polycarbonates, preferably at least one polyol which contains ester groups and has a number average molecular weight of 350 to 4000 g/mol, preferably 350 to 2000 g/mol, more preferably 350 to 1000 g/mol. The preferred average OH functionality is 2 to 4 OH groups per molecule.

Examples of polyols containing ester groups include the known polyester polyols, which are synthesized from low molecular weight polyols and dicarboxylic acids. Examples of suitable low molecular weight polyols include 1,4-butanediol, 1,3-butanediol, 1,6-hexanediol, 2,2,4-trimethyl-1,3-pentanediol, trimethylol propane, pentaerythritol or sorbitol. Examples of suitable dicarboxylic acids include aromatic dicarboxylic acids such as phthalic acid, isophthalic acid and terephthalic acid; cycloaliphatic dicarboxylic acids such as hexahydrophthalic -acid, tetrahydrophthalic acid, endomethylene tetrahydrophthalic acid and/or their anhydrides; and aliphatic dicarboxylic acids, such as succinic acid, glutaric acid, adipic acid, suberic acid, azeleic acid, sebacic acid and/or their anhydrides. It is preferred to use aliphatic dicarboxylic acids to synthesize the ester diols.

Preferred polyester polyols for use in component b2) are the polycaprolactone diols having a number average molecular weight of 350 to 4000 g/mol, preferably 350 to 2000 g/mol, and more preferably 350 to 1000 g/mol. These compounds are obtained in known manner from a diol, triol or diol/triol mixture of the type exemplified above, as starter, and ε-caprolactone. Preferred polycaprolactone diols are prepared by polymerizing ε-caprolactone using 1,6-hexanediol as the starter.

Particularly preferred polyester polyols are those prepared from adipic acid, phthalic acid, isophthalic acid and tetrahydrophthalic acid.

Also suitable for use as component b2) are the polyethers of ethylene oxide, propylene oxide and/or tetrahydrofuran. Preferred are polyethers having a number average molecular weight of 500 to 2000 g/mol, such as polyethylene oxides or polytetrahydrofuran diols.

Additionally, component b2) includes hydroxyl-containing polycarbonates such as hexanediol polycarbonate or polyester carbonates, having a preferred number average molecular weight of 400 to 4000 g/mol, more preferably 400 to 2000 g/mol.

Examples of suitable monofunctional linear polyethers for use as component b3) include polyethers of ethylene oxide and/or propylene oxide. Preference is given to polyalkylene oxide polyethers prepared starting from monoalcohol and having a number average molecular weight of 350 to 2500 g/mol, and containing at least 70% of ethylene oxide units. Particularly preferred are polymers having more than 75% of ethylene oxide units and a number average molecular weight of 300 to 2500 g/mol, preferably 500 to 1000 g/mol. Starter molecules used in the preparation of these polyethers are preferably monofunctional alcohols having 1 to 6 carbon atoms.

The polyisocyanates that may be used to prepare the blocked polyisocyanates are selected from those that have previously been set forth for use as components a1) to a4). These polyisocyanates may additionally contain hydrophilic groups. Hydrophilic agents that may be present in incorporated form the cationic, anionic and/or nonionic compounds that are known for this purpose. Examples include mono- and/or dihydroxycarboxylic acids or monofunctional alkyl ethoxylates. It is also possible to use mixtures of different hydrophilic agents. Preferred are dimethylol propionic acid and/or monofunctional alkyl ethoxylates.

Mixtures of hydrophilic and non-hydrophilic (hydrophobic) polyisocyanates may also be employed. The hydrophilic agents are used preferably in an amount that is not sufficient for the preparation of stable dispersions of the blocked polyisocyanates. These amounts are easily determined by routine tests.

When the polyisocyanates employed here are added in blocked form either before the reaction of components a1) to a4) or after this reaction, the NCO groups of the blocked polyisocyanates are blocked with known blocking agents. Examples include ε-caprolactam, diethyl malonate, ethyl acetoacetate, oximes such as butanone oxime, diisopropylamine, ester amines such as alkylalanine esters, tert-butylbenzylamine, dimethylpyrazole, triazole and mixtures thereof. Preferred are ε-caprolactam, butanone oxime, diisopropylamine, 3,5-dimethylpyrazole, triazole and mixtures thereof.

The amount of free NCO groups in these blocked polyisocyanates is preferably less than 1% by weight, more preferably less than 0.1% by weight.

Instead of adding the blocked polyisocyanates previously set forth, it is also possible following the reaction of components a1) to a4) to add polyisocyanates having free NCO groups, which are then blocked in situ. Suitable blocking agents are those set forth above. In this embodiment the blocking agents are used in amounts such that after the blocking reaction preferably more than 90%, more preferably more than 99%, of the NCO groups are present in blocked form.

To accelerate the blocking reaction it is possible to use catalysts such as tertiary amines, tin compounds, zinc compounds or bismuth compounds, especially triethylamine, 1,4-diazabicyclo[2.2.2]octane, tin dioctoate or dibutyltin dilaurate.

The conditions for such blocking in situ are known. After blocking agent and the isocyanate component to be blocked have been introduced, stirring is typically carried out until free isocyanate groups are no longer detectable. In addition to the use of a single blocking agent it is also possible to carry out the blocking reaction using mixtures of two or more blocking agents with the polyisocyanates, which may also be in the form of a mixture.

In another embodiment it is possible to react only a portion of the free NCO groups of polyisocyanate with the blocking agents and then to react the remaining NCO groups to form uretdione-, allophanate- and/or biuret-modified polyisocyanates.

During the process of the invention it is possible to use solvents, which may be removed following the preparation. In addition, it is also possible to employ catalysts, cosolvents, and other additives.

During the process of the invention it is also possible to add a relatively large amount of a (partly) water-miscible solvent such as acetone or methyl ethyl ketone to the reaction mixture. When the reaction has been concluded, water is added to the reaction mixture and the solvent is removed by distillation. This is referred to as the acetone or slurry method. The advantage of this procedure lies in the low amount of solvent in the finished dispersion.

Examples of neutralizing agents as) include triethylamine, dimethylaminoethanol, dimethylcyclohexylamine, triethanolamine, methyldiethanolamine, diisopropanolamine, ethyldiisopropylamine, diisopropylcyclohexylamine, N-methylmorpholine, 2-amino-2-methyl-1-propanol, ammonia or mixtures thereof. Preferred neutralizing agents are tertiary amines such as triethylamine, diisopropylhexylamine and dimethylethanolamine; dimethylethanolamine is particularly preferred.

The amount of neutralizing agent used is generally calculated such that the degree of neutralization of the carboxylic and/or sulphonic acid groups present in the polyurethanes of the invention (molar ratio of amine employed to acid groups present) is at least 50%, preferably 80% to 120%, and more preferably 95% to 105%. Neutralization may take place before, during or after the dispersing or dissolving step. Preferably, neutralization takes place prior to the addition of water.

The individual process steps can all be carried out in a single reaction vessel or else steps can be carried out in different reaction vessels and the resulting intermediates can be combined for further reaction.

Prior to dispersing in water the self-crosslinking polyurethanes contain 5% to 50%, preferably 8% to 40%, and more preferably 10% to 30% by weight of the NCO- or OH-functional prepolymer; 0.1% to 20%, preferably 1% to 10%, and more preferably 1% to 5% by weight of component a4); 20% to 90%, preferably 40% to 80%, and more preferably 50% to 70% by weight of component a3); 2% to 50%, preferably 5% to 30%, and more preferably 10% to 25% of a blocked polyisocyanate; and 0.01% to 10%, preferably 0.5% to 5%, and more preferably 1% to 3% by weight of component as). The preceding percentages are based on the solids content of the components and their total is 100%, based on the weight of the components.

In another preferred embodiment, 5% to 50%, preferably 10% to 40%, and more preferably 10% to 30% by weight of the NCO- or OH-functional prepolymer is prepared in 2% to 40%, preferably 5% to 30%, and more preferably 10% to 25% of a blocked polyisocyanate and the prepolymer is admixed with 0.1% to 20%, preferably 1% to 10%, more preferably 1% to 5% by weight of component a4), 30% to 90%, preferably 40% to 80%, and more preferably 50% to 70% by weight of component a3), and 0.01% to 10%, preferably 0.5% to 5%, and more preferably 1% to 3% by weight of component a5), prior to dispersion in water. The preceding percentages are based on the solids content of the components and their total is 100%, based on the weight of the components.

In another preferred embodiment 5% to 50%, preferably 10% to 40%, and more preferably 10% to 30% by weight of the NCO- and/or OH-functional prepolymer are reacted with 0.1% to 20%, preferably 1% to 10%, and more preferably 1% to 5% by weight of component a4), and 30% to 90%, preferably 40% to 80%, and more preferably 50% to 70% by weight of component a3), and then amounts of a blocking agent and polyisocyanate are added which are sufficient to form 2% to 40%, preferably 5% to 30%, and more preferably 10% to 25% of a blocked polyisocyanate. This mixture is then admixed with 0.01% to 10%, preferably 0.5% to 5%, and more preferably 1% to 3% by weight of component a5), prior to dispersion in water. The preceding percentages are based on the solids content of the components and their total is 100%, based on the weight of the components.

The dispersions obtained in accordance with the invention preferably have solids contents of 30% to 60% by weight, more preferably 40% to 50% by weight.

The dispersions obtained by the process of the invention can be used as one-component baking systems, containing free hydroxyl groups, for the preparation of varnishes, paints and other formulations. In these applications it is possible to use the known additives from coatings technology, such as pigments, flow control agents, additives that prevent bubbles or blisters, and catalysts.

The present invention also relates to paints, varnishes or adhesives, containing the dispersion according to the invention, which are suitable for automotive OEM finishing, and also for can coating and coil coating.

The aqueous one-component coating compositions can be applied by any desired methods of coating technology, such as spraying, spreading, dipping, flooding, or using rollers and doctor blades, to any heat-resistant substrates, in one or more coats. The coating films generally have a dry thickness of 0.001 to 0.3 mm. Examples of suitable substrates include metal, plastic, wood or glass. The coating film is cured at 80 to 260° C., preferably at 130 to 260° C.

The aqueous one-component coating compositions are preferably suitable for producing coatings and paint systems on steel sheets such as those used for producing vehicle bodies, machinery, panels, drums or containers. They are especially preferred for the preparation of automotive surfacers and/or topcoat materials.

The invention is further illustrated but is not intended to be limited by the following examples.

### EXAMPLES

Desmodur 44M: monomeric diphenylmethane 4,4′-diisocyanate, isocyanate content 34% by weight, Bayer MaterialScience AG, Leverkusen, DE

Desmodur VL R 20: aromatic polyisocyanate based on diphenylmethane diisocyanate, isocyanate content 31.5% by weight, Bayer MaterialScience AG, Leverkusen, DE

Pluriol A 500E: polyethylene glycol monomethyl ether, molecular weight 500 g/mol, BASF, Ludwigshafen, DE

Desmodur Z 4470 M/X: aliphatic polyisocyanate trimer prepared from isophorone diisocyanate, 70% by weight solution in a mixture of methoxypropyl acetate and xylene (1/1), isocyanate content 12% by weight, Bayer MaterialScience AG, Leverkusen, DE

Desmodur Z 4470: aliphatic polyisocyanate trimer prepared from isophorone diisocyanate, isocyanate content 17% by weight, Bayer MaterialScience AG, Leverkusen, DE

Desmodur VP LS 2253: blocked aliphatic polyisocyanate based on hexa-methylene diisocyanate, isocyanate content 11% by weight (blocked), Bayer MaterialScience AG, Leverkusen, DE

Shellsol SN 100: aromatic hydrocarbon mixture, boiling range 160-180° C., Shell AG

Unless indicated otherwise, all percentages are by weight.

The reported viscosities were determined by means of rotational viscometry according to DIN 53019 at 23° C., using a rotational viscometer from Anton Paar Germany GmbH, Ostfildern, DE.

NCO contents, unless expressly stated otherwise, were determined volumetrically in accordance with DIN-EN ISO 11909.

The reported particle sizes were determined by means of laser correlation spectroscopy (instrument: Malvern Zetasizer 1000, Malvern Inst. Limited). Checking for free NCO groups was carried out by means of IR spectroscopy (band at 2260 cm⁻¹).

### Example 1

468.8 g of Desmodur 44M were admixed dropwise with 37.1 g of 1-butanol at 80° C. with stirring. After 1 hour the catalyst (0.05 g of zinc (2-ethylhexanoate)₂, 50% in MPA) was added and the batch was stirred at 80° C. for 12 hours more, during which the NCO content fell to about 21.8% (theoretical 22.8%). Thereafter 497 g of N-methylpyrrolidone were supplied and the batch was cooled to room temperature. Subsequently 239.3 g of butanone oxime were added dropwise at a rate such that an exothermic reaction raised the temperature of the batch to about 70° C. It was then stirred at 70° C. until free NCO groups were no longer detected by IR spectroscopy (about 1 hour). The resulting product was a pale yellow liquid having a solids content of 60% and a viscosity of 7000 mPa.s, which did not crystallize even after several months.

### Example 2

132 g of Desmodur VL R 20 were dissolved in 146 g of N-methylpyrrolidone at room temperature with stirring. The homogeneous mixture was admixed dropwise with 87 g of butanone oxime at 50° C. at a rate such that an exothermic reaction raised the temperature of the batch to about 80° C. It was then stirred at 80° C. until free NCO groups were no longer detected by IR spectcroscopy (about 1 hour). The resulting product was a brown liquid having a solids content of 60% and a viscosity of 1320 mPa.s, which remained stable to crystallization for more than a year.

### Example 3

132 g of Desmodur VL R 20 were dissolved in 150 g of N-methylpyrrolidone at 80° C. with stirring. The homogeneous mixture was admixed dropwise with 9.9 g of 1-butanol at 80° C. After 1 hour the catalyst (0.01 g of zinc (2-ethylhexanoate)₂, 50% in MPA) was added and the batch was stirred at 80° C. for a further hour, during which the NCO content fell to about 10.4% (theoretical 10.5%). Thereafter the batch was cooled to 50° C. and 83.5 g of 3,5-dimethylpyrazole were added at a rate such that an exothermic reaction raised the temperature of the batch to about 70° C. It was then stirred at 70° C. until free NCO groups were no longer detected by IR spectroscopy (about 2 hours). The resulting product was a brown liquid having a solids content of 60% and a viscosity of 700 mPa.s, which remained storage-stable for up to about 8 months.

### Example 4

132 g of Desmodur VL R 20 were introduced into a vessel with 13.2 g of Pluriol A 500E with stirring and this initial charge was heated to 80° C. The homogeneous mixture was admixed with the catalyst (0.015 g of dibutyltin dilaurate) at 80° C. and the batch was stirred at 80° C. for an hour, during which the NCO content fell to about 27.1% (theoretical 28.2%). Subsequently the batch was diluted with 151 g of N-methylpyrrolidone and cooled to 50° C. Thereafter 82 g of butanone oxime were added dropwise at a rate such that an exothermic reaction raised the temperature of the batch to about 80° C. It was then stirred at 80° C. until free NCO groups were no longer detected by IR spectroscopy (about an hour). The resulting product was a brown liquid having a solids content of 60% and a viscosity of 1200 mPa.s, which remained stable to crystallization for more than a year.

### Example 5

503.2 g of Desmodur VL R 20 were dissolved in 584 g of N-methylpyrrolidone at 80° C. with stirring. The homogeneous mixture was admixed dropwise with 13.4 g of diethylene glycol monomethyl ether at 80° C. After 1 hour the catalyst (0.04 g of zinc (2-ethylhexanoate)₂, 50% in MPA) was added and the batch was stirred at 80° C. for a further half an hour, during which the NCO content fell to about 12.8% (theoretical 13.5%). Thereafter the batch was cooled to 30° C. and 359.2 g of diisopropylamine were added dropwise at a rate such that an exothermic reaction raised the temperature of the batch to about 70° C. It was then stirred at 80° C. until free NCO groups were no longer detected by IR spectroscopy (about half an hour). The resulting product was a brown liquid having a solids content of 60% and a viscosity of 2910 mPa.s, which remained stable to crystallization for more than a year.

### Example 6

316.8 g of Desmodur VL R 20 were dissolved in 303.7 g of methoxypropyl acetate at room temperature with stirring. The homogeneous mixture was admixed dropwise with 352.64 g of N-benzyl-N-tert-butylamine at a rate such that an exothermic reaction raised the temperature of the batch to about 50° C. It was then stirred at 50° C. until the NCO content remained constant. Subsequently a further 19.59 g of N-benzyl-N-tert-butylamine were added dropwise and the batch was again stirred at 50° C. until the NCO content remained constant. Finally 1.96 g of N-benzyl-N-tert-butylamine were added dropwise and the batch was stirred until free NCO groups were no longer detected by IR spectroscopy (about an hour). The resulting product was a brown liquid having a solids content of 60% and a viscosity of 7500 mPa.s.

### Example 7

95.41 g (0.43 mol) of isophorone diisocyanate were admixed with a solution of 28.77 g (0.215 mol) of dimethylolpropionic acid in 57.54 g of N-methylpyrrolidone, at 50° C., and the mixture was then heated to 80° C. and stirred for 90 minutes. Its NCO content was then 9.33%. 28.08 g (0.078 eq NCO) of Desmodur Z 4470 M/X and 446.7 g (1.4 eq OH) of a polyester made from adipic acid, isophthalic acid, trimethylolpropane, neopentyl glycol and propylene glycol and having an OH number of 189, were added with stirring, and this mixture was stirred for 90 minutes; no further NCO groups were then detected by IR spectroscopy. Subsequently 164.18 g (1.73 eq blocked NCO) of the compound from Example 2 were added at 70° C., stirring took place for 10 minutes, and then 19.12 g (0.215 mol) of dimethylethanolamine were metered in, followed by stirring for 30 minutes. The batch was then dispersed with 733.9 g of deionized water having a temperature of 70° C., followed by stirring at 50° C. for 1 hour and cooling for 4 hours with stirring. The resulting dispersion possessed the following properties:

| | |
|---|---|
| Solids content | 41% |
| pH | 6.97 |
| Viscosity | 2350 mPa · s |
| Particle size (laser correlation spectroscopy, LCS) | 29 nm |

### Example 8

114.68 g (0.5015 mol) of isophorone diisocyanate were admixed with 38.92 g (0.29 mol) of dimethylolpropionic acid in solution in 93.07 g of N-methylpyrrolidone at 50° C. with stirring, and the mixture was heated to 50° C. and stirred at 85° C. for 3.5 hours. The NCO content of the reaction mixture was then 7.42% (calculated: 7.66%). Thereafter 19.37 g (0.085 mol) of isophorone diisocyanate, 21.06 g (0.06 eq NCO) of Desmodur Z 4470, 335.0 g (1.05 eq OH) of a polyester made from adipic acid, isophthalic acid, trimethylolpropane, neopentyl glycol and propylene glycol and having an OH number of 189, 323.70 g (0.82 eq OH) of a polyester made from isophthalic acid, adipic acid, hexane-1,6-diol, trimethylolpropane and phthalic anhydride and having an OH number of 254, and 77.4 g (0.045 mol) of a polyester made from adipic acid, hexane-1,6-diol and neopentyl glycol and having a number average molecular weight of 1700, were added and the mixture was stirred at 85° C. for two hours. Thereafter NCO groups were no longer detected by IR spectroscopy. After the mixture had cooled to 70° C., 123.14 g (0.34 eq blocked NCO) of the compound from Example 2 were added, followed by 30 minutes of stirring, cooling to 60° C., the addition of 25.91 g (0.29 mol) of dimethylethanolamine, and a further 30 minutes of stirring. Subsequently 1102.4 g of deionized water having a temperature of 70° C. were added and the batch was subsequently stirred at 60° C. for 60 minutes and left to cool with stirring. The resulting dispersion possessed the following properties:

| | |
|---|---|
| Solids content | 45.4% |
| pH | 7.72 |
| Viscosity | 4100 mPa · s |
| Particle size (laser correlation spectroscopy, LCS) | 45 nm |

### Example 9

147.90 g (0.665 mol) of isophorone diisocyanate were admixed with 50.30 g (0.375 mol) of dimethylolpropionic acid in solution in 100.60 g of N-methylpyrrolidone at 50° C. with stirring, and the mixture was heated to 85° C. and stirred at 85° C. for 3.5 hours. The NCO content of the reaction mixture was then 7.99% (calculated: 8.15%). Thereafter 4.45 g (0.02 mol) of isophorone diisocyanate, 21.06 g (0.06 eq NCO) of Desmodur Z 4470, (Bayer AG, Leverkusen) 335.0 g (1.05 eq OH) of a polyester made from adipic acid, isophthalic acid, trimethylolpropane, neopentyl glycol and propylene glycol, having an OH number of 189, 323.70 g (0.82 eq OH) of a polyester made from isophthalic acid, adipic acid, hexane-1,6-diol, trimethylolpropane and phthalic anhydride and having an OH number of 254, and 77.4 g (0.045 mol) of a polyester made from adipic acid, hexane-1,6-diol and neopentyl glycol and having a number average molecular weight of 1700, were added and the mixture was stirred at 85° C. for two hours. Thereafter NCO groups were no longer detected by IR spectroscopy. After the mixture had cooled to 70° C., 252.80 g (0.64 eq blocked NCO) of the compound from Example 2 were added, followed by 30 minutes of stirring, cooling to 60° C., the addition of 33.43 g (0.375 mol) of dimethylethanolamine, and a further 30 minutes of stirring. Subsequently 1499.8 g of deionized water having a temperature of 70° C. were added and the batch was subsequently stirred at 60° C. for 60 minutes and left to cool with stirring. The resulting dispersion possessed the following properties:

| | |
|---|---|
| Solids content | 39.9% |
| pH | 7.85 |
| Viscosity | 200 mPa · s |
| Particle size (laser correlation spectroscopy, LCS) | 41 nm |

### Example 10

The procedure described in Example 7 was repeated with the exception that the compound from Example 2 was replaced by 179.40 g of Desmodur VP LS 2253 and 1027.8 g of water. The resulting dispersion possessed the following properties:

| | |
|---|---|
| Solids content | 42% |
| pH | 7.69 |
| Viscosity | 900 mPa · s |
| Particle size (laser correlation spectroscopy, LCS) | 49 nm |

### Example 11

The procedure described in Example 7 was repeated with the exception that the compound from Example 2 was replaced by 148.93 g of the compound from Example 1. The resulting dispersion possessed the following properties:

| | |
|---|---|
| Solids content | 42% |
| pH | 7.80 |
| Viscosity | 1600 mPa · s |
| Particle size (laser correlation spectroscopy, LCS) | 309 nm |

### Example 12

The procedure described in Example 7 was repeated with the exception that the compound from Example 2 was replaced by 168.68 g of the compound from Example 3. The resulting dispersion possessed the following properties:

| | |
|---|---|
| Solids content | 45% |
| pH | 7.54 |
| Viscosity | 4200 mPa · s |
| Particle size (laser correlation spectroscopy, LCS) | 40 nm |

### Example 13

The procedure described in Example 7 was repeated with the exception that the compound from Example 2 was replaced by 164.88 g of compound from Example 4. The resulting dispersion possessed the following properties:

| | |
|---|---|
| Solids content | 45% |
| pH | 7.85 |
| Viscosity | 1600 mPa · s |
| Particle size (laser correlation spectroscopy, LCS) | 78 nm |

### Example 14

95.41 g of isophorone diisocyanate were admixed with a solution of 30.18 g of dimethylolpropionic acid in 52.58 g of methoxypropyl acetate and 7.78 g of N-methylpyrrolidone at 50° C., and the mixture was heated to 80° C. and stirred for 90 minutes until its NCO content remained constant. 12.64 g of Desmodur Z 4470 M/X and 186.67 g of a polyester made from adipic acid, isophthalic acid, trimethylolpropane, neopentyl glycol and propylene glycol and having an OH number of 189, 194.19 g of a polyester made from isophthalic acid, adipic acid, hexane-1,6-diol, trimethylolpropane and phthalic anhydride and having an OH number of 254, and 85.72 g of a polyester made from adipic acid, hexane-1,6-diol and neopentyl glycol and having a number average molecular weight of 1700, were added with stirring and the mixture was stirred at 85° C. for 2 hours. NCO groups were then no longer detected by IR spectroscopy. Subsequently 178.3 g of the compound from Example X1 were added at 70° C., followed by 10 minutes of stirring, after which 19.12 g of dimethylethanolamine were metered in and the mixture was stirred for 30 minutes. It was then dispersed with 945 g of deionized water having a temperature of 70° C., stirred at 50° C. for an hour and cooled for 4 hours with stirring. The resulting dispersion possessed the following properties:

| | |
|---|---|
| Solids content | 40% |
| pH | 8.67 |
| Viscosity | 1350 mPa · s |
| Particle size (laser correlation spectroscopy, LCS) | 60 nm |

The following 2 examples demonstrate the embodiment of synthesizing a polymer system in the presence of blocked isocyanates. This embodiment has the advantage that only one reactor is required and the transfer of the first stage is omitted.

### Example 15

132 g of Desmodur VL R 20 (Bayer AG, Leverkusen) were dissolved in 146 g of N-methylpyrrolidone at room temperature with stirring. The homogeneous mixture was admixed dropwise with 87 g of butanone oxime at 50° C. and at a rate such that an exothermic reaction raised the temperature of the batch to about 80° C. It was then stirred at 80° C. until free NCO groups were no longer detected by IR spectroscopy (about an hour). Thereafter 147.90 g (0.665 mol) of isophorone diisocyanate were added, 50.30 g (0.375 mol) of dimethylolpropionic acid in solution in 100.60 g of N-methylpyrrolidone were added at 50° C. with stirring, and the mixture was heated to 85° C. and stirred at 85° C. for 3.5 hours. The NCO content of the reaction mixture was then 4.43% (calculated: 4.42%). Thereafter 4.45 g (0.02 mol) of isophorone diisocyanate, 21.06 g (0.06 eq NCO) of Desmodur Z 4470 (Bayer AG, Leverkusen), 335.0 g (1.05 eq OH) of a polyester made from adipic acid, isophthalic acid, trimethylolpropane, neopentyl glycol and propylene glycol and having an OH number of 189, 323.70 g (0.82 eq OH) of a polyester made from isophthalic acid, adipic acid, hexane-1,6-diol, trimethylolpropane and phthalic anhydride and having an OH number of 254, and 77.4 g (0.045 mol) of a polyester made from adipic acid, hexane-1,6-diol and neopentyl glycol and having a number average molecular weight of 1700, were added and the mixture was stirred at 85° C. for 2 hours. Thereafter NCO groups were no longer detected by IR spectroscopy. After the mixture had cooled to 60° C., 33.43 g (0.375 mol) of dimethylethanolamine were added, followed by stirring for 30 minutes. Subsequently 1369.3 g of deionized water having a temperature of 70° C. were added, followed by stirring at 60° C. for 60 minutes and by cooling with stirring. The resulting dispersion possessed the following properties:

| | |
|---|---|
| Solids content | 42% |
| pH | 8.26 |
| Viscosity (Haake rotational viscometer, 23° C.) | 210 mPa · s |
| Particle size (laser correlation spectroscopy, LCS) | 70 nm |

### Example 16

85.72 g of Desmodur VL R 20 (Bayer AG, Leverkusen) were dissolved in 94.81 g of N-methylpyrrolidone at room temperature with stirring. The homogeneous mixture was admixed dropwise with 56.50 g of butanone oxime at 50° C. and at a rate such that an exothermic reaction raised the temperature of the batch to about 80° C. It was then stirred at 80° C. until free NCO groups were no longer detected by IR spectroscopy (about an hour). Thereafter 28.77 g of dimethylolpropionic acid in solution with 57.54 g of N-methylpyrrolidone, and 107.25 g of 4,4′-diisocyanatodiphenylmethane, were added at 50° C. and the mixture was stirred for an hour. The NCO content of the reaction mixture was 8.74% (calc.: 9.31%). Then 446.72 g (1.40 eq OH) of a polyester made from adipic acid, isophthalic acid, trimethylolpropane, neopentyl glycol and propylene glycol and 10.30 g (0.078 eq NCO) of Desmodur VLR 20 (Bayer AG, Leverkusen) were added and the mixture was stirred until NCO groups were no longer detected by IR spectroscopy (3 hours). Then 19.12 g of dimethylethanolamine were added at 50° C., followed by 20 minutes of stirring and dispersing with 745.4 g. of deionized water at 50° C. The resulting dispersion possessed the following properties:

| | |
|---|---|
| Solids content | 45% |
| pH | 7.93 |
| Viscosity (Haake rotational viscometer, 23° C.) | 1370 mPa · s |
| Particle size (laser correlation spectroscopy, LCS) | 58 nm |

### Example 17

55.89 g (0.414 eq NCO) of Desmodur VLR 20 (Bayer AG, Leverkusen) were dissolved in 60.36 g of methoxypropyl acetate/butyl acetate (1:1, weight/weight) at room temperature with stirring. Over the course of 30 minutes, 36.07 g (0.414 eq) of butanone oxime were added dropwise, during which the temperature rose to 70° C. After a further 30 minutes of stirring at 70° C. NCO groups were no longer detected by IR spectroscopy. Subsequently 30.18 g (0.45 eq OH) of dimethylolpropionic acid and 91.41 g (0.822 eq OH) of isophorone diisocyanate were added and the reaction mixture was stirred at 80° C. for 200 minutes; the NCO content was then 5.69% (calc.: 5.70%). Following the addition of 12.64 g (0.036 eq NCO) of Desmodur Z 4470 (Bayer AG, Leverkusen), 186.67 g (0.585 eq OH) of a polyester made from adipic acid, isophthalic acid, trimethylolpropane, neopentyl glycol and propylene glycol and having an OH number of 189, 194.19 g (0.492 eq OH) of a polyester made from isophthalic acid, adipic acid, hexane-1,6-diol, trimethylolpropane and phthalic anhydride and having an OH number of 254, and 85.72 g (0.0495 eq) of a polyester made from adipic acid, hexane-1,6-diol and neopentyl glycol having a number average molecular weight of 1700, the mixture was stirred at 85° C. for 2 hours. Thereafter NCO groups were no longer detected by IR spectroscopy. After the mixture had cooled to 70° C., 20.06 g (0.225 mol) of dimethylethanolamine were added, followed by 30 minutes of stirring. Subsequently 875.72 g of deionized water having a temperature of 50° C. were added, followed by stirring at 60° C. for 60 minutes and by cooling over the course of 5 hours with stirring. The resulting dispersion possessed the following properties:

| | |
|---|---|
| Solids content | 42% |
| pH | 8.43 |
| Viscosity | 5950 mPa · s |
| Particle size (laser correlation spectroscopy, LCS) | 57 nm |

### Example 18

The procedure described in Example 17 was repeated with the exception that the methoxypropyl acetate/butyl acetate mixture was replaced by 60.36 g of methoxypropyl acetate. The resulting dispersion possessed the following properties:

| | |
|---|---|
| Solids content | 42% |
| pH | 8.2 |
| Viscosity (Haake rotational viscometer, 23° C.) | 930 mPa · s |
| Particle size (laser correlation spectroscopy, LCS) | 195 nm |

The following examples relate to blocking the free isocyanate groups in the reaction mixture. In this case it is unexpected that the blocking reaction proceeds well despite the fact that in addition to the blocking agent there is an excess of hydroxyl groups. The desired blocking is unexpectedly much quicker than the alcohol-isocyanate reaction, and yet thermodynamic reasons dictate that in each case both reactions must take place.

### Example 19

91.41 g (0.41 mol) of isophorone diisocyanate were admixed with 30.18 g (0.225 mol) of dimethylolpropionic acid in solution in 60.36 g of methoxypropyl acetate at 50° C. with stirring, and the mixture was heated to 85° C. and stirred at 85° C. for 3.5 hours. The NCO content of the reaction mixture was then 8.55% (calculated: 8.59%). Thereafter 12.64 g (0.036 eq NCO) of Desmodur Z 4470, 201.02 g (0.63 eq OH) of a polyester made from adipic acid, isophthalic acid, trimethylolpropane, neopentyl glycol and propylene glycol and having an OH number of 189, 194.19 g (0.492 eq OH) of a polyester made from isophthalic acid, adipic acid, hexane-1,6-diol, trimethylolpropane and phthalic anhydride and having an OH number of 254, and 46.43 g (0.054 mol) of a polyester made from adipic acid, hexane-1,6-diol and neopentyl glycol and having a number average molecular weight of 1700, were added and the mixture was stirred at 85° C. for 2 hours. Thereafter NCO groups were no longer detected by IR spectroscopy. After the mixture had cooled to 50° C., 19.04 g of Shellsol SN 100, 9.38 g of methoxypropyl acetate and 33.41 g (0.384 mol) of butanone oxime were added and then 51.84 g (0.384 eq NCO) of Desmodur VLR 20 were added at a rate such that the temperature did not exceed 60° C. (about 15 minutes). After a further 15 minutes NCO groups were no longer detected by IR spectroscopy. Then 20.06 g (0.225 mol) of dimethylethanolamine were added at 60° C., the mixture was stirred for 10 minutes and dispersed with 923.5 g of deionized water having a temperature of 60° C., stirred again at 60° C. for 60 minutes and left to cool to room temperature over the course of 4 hours with stirring. The resulting dispersion possessed the following properties:

| | |
|---|---|
| Solids content | 40% |
| pH | 8.0 |
| Viscosity (Haake rotational viscometer, 23° C.) | 840 mPa · s |
| Particle size (laser correlation spectroscopy, LCS) | 41 nm |

### Example 20

91.41 g (0.41 mol) of isophorone diisocyanate were admixed with 30.18 g (0.225 mol) of dimethylolpropionic acid and 60.36 g of methoxypropyl acetate at 50° C. with stirring and the mixture was stirred at 85° C. for 2 hours; the NCO content was 8.06% (calc.: 8.58%). Then 12.64 g (0.036 eq NCO) of Desmodur Z 4470, 186.67 g (0.585 eq OH) of a polyester made from adipic acid, isophthalic acid, trimethylolpropane, neopentyl glycol and propylene glycol and having an OH number of 189, 194.19 (0.492 eq OH) of a polyester made from isophthalic acid, adipic acid, hexane-1,6-diol, trimethylolpropane and phthalic anhydride and having an OH number of 254, and 85.72 g (0.099 eq OH) of a polyester made from adipic acid, hexane-1,6-diol and neopentyl glycol and having a number average molecular weight of 1700, were added and the mixture was stirred at 85° C. for 2 hours. Thereafter NCO groups were no longer detected by IR spectroscopy. After the mixture had cooled to 50° C., 36.07 g (0.414 mol) of butanone oxime were added and then 55.89 g (0.414 eq NCO) of Desmodur VLR 20 were added at a rate such that the temperature did not exceed 60° C. (about 15 minutes). After a further 15 minutes of stirring NCO groups were no longer detected by IR spectroscopy. Then 20.06 g (0.225 mol) of dimethylethanolamine were added at 60° C., stirring was carried out for 10 minutes, the batch was dispersed with 875.72 g of deionized water having a temperature of 60° C., stirring was continued at 60° C. for 60 minutes, and the batch was left to cool to room temperature with stirring (4 hours). The dispersion possessed the following properties:

| | |
|---|---|
| Solids content | 43% |
| pH | 7.93 |
| Viscosity (Haake rotational viscometer, 23° C.) | mPa · s |
| Particle size (laser correlation spectroscopy, LCS) | 52 nm |

### Example 21

The procedure described in Example 20 was repeated with the exception that methoxypropyl acetate was replaced by a mixture of butyl acetate and methoxypropyl acetate in a ratio of 1:1 (weight/weight). The resulting dispersion possessed the following properties:

| | |
|---|---|
| Solids content | 41% |
| pH | 8.24 |
| Viscosity (Haake rotational viscometer, 23° C.) | 3850 mPa · s |
| Particle size (laser correlation spectroscopy, LCS) | 45 nm |

### Example 22

100.55 g (0.452 mol) of isophorone diisocyanate were admixed with 33.20 g (0.248 mol) of dimethylolpropionic acid in solution in 66.40 g of methoxypropyl acetate at 50° C. with stirring, and the mixture was heated to 85° C. and stirred at 85° C. for 3.5 hours. The NCO content of the reaction mixture was then 8.10% (calculated: 8.58%). Thereafter 201.02 g (0.63 eq OH) of a polyester made from adipic acid, isophthalic acid, trimethylolpropane, neopentyl glycol and propylene glycol and having an OH number of 189, 194.19 g (0.492 eq OH) of a polyester made from isophthalic acid, adipic acid, hexane-1,6-diol, trimethylolpropane and phthalic anhydride and having an OH number of 254, and 46.43 g (0.054 eq OH) of a polyester made from adipic acid, hexane-1,6-diol and neopentyl glycol and having a number average molecular weight of 1700, were added and the mixture was stirred at 85° C. for 2 hours. Thereafter NCO groups were no longer detected by IR spectroscopy. After the mixture had cooled to 50° C., 33.41 g (0.384 mol) of butanone oxime were added and then 51.84 g (0.384 eq NCO) of Desmodur VLR 20 were added at a rate such that the temperature did not exceed 60° C. (about 15 minutes). After a further 15 minutes, NCO groups were no longer detected by IR spectroscopy. Then 22.09 g (0.248 mol) of dimethylethanolamine were added at 60° C., the mixture was stirred for 10 minutes and dispersed with 957.7 g of deionized water having a temperature of 60° C., stirred again at 60° C. for 60 minutes and left to cool to room temperature over the course of 4 hours with stirring. The resulting dispersion possessed the following properties:

| | |
|---|---|
| Solids content | 40% |
| pH | 7.79 |
| Viscosity (Haake rotational viscometer, 23° C.) | 230 mPa · s |
| Particle size (laser correlation spectroscopy, LCS) | 44 nm |

### Comparative Example 1

The procedure described in Example 7 was repeated with the exceptions that 1) all of the components were reacted at once, i.e. randomly, in accordance with WO 02/14395 (U.S. Application No. 2002/165334) and 2) the compound from Example 2 was not added. The resulting dispersion possessed the following properties:

| | |
|---|---|
| Solids content | 23.7% |
| pH | 7.93 |

Viscosity (Haake rotational viscometer, 23° C.) pasty, value not measurable

Particle size (laser correlation spectroscopy, LCS) pasty, value not measurable

Even with a significantly reduced solids content (dilution took place to 23.7% instead of 41% in Example 7), it was not possible to obtain a stable dispersion in accordance with the comparative example. The resulting product was pasty.

The performance properties of the dispersions of the invention are set forth in Table 1.

Clearcoat compositions were prepared from the components set forth below. The clearcoat compositions were used to produce films, which were dried at room temperature for 10 minutes and then baked at 140° C. or 160° C. for 30 minutes. The films obtained were subjected to performance assessment.

The pendulum hardnesses were measured by the Konig method in accordance with DIN 53157.

The ability to dissolve (dissolvability) the coatings was assessed after 1 minute of exposure to each solvent, the sequence of the solvents being as follows: xylene/methoxypropyl acetate/ethyl acetate/acetone—assessment: 0, very good to 5, poor.

TABLE 1

| | Dispersion from Example No. | | | | | | |
|---|---|---|---|---|---|---|---|
| | 7 | 8 | 9 | 10 | 11 | 12 | 13 |
| Initial product mass [g] | 150 | 150 | 150 | 150 | 150 | 150 | 150 |
| Additol XW 395, as-supplied form [g] | 1.1 | 1.2 | 1.1 | 1.2 | 1.1 | 1.1 | 1.2 |
| Surfynol 104, 50% in NMP [g] | 1.1 | 1.2 | 1.1 | — | 1.1 | 1.1 | 1.2 |
| DMEA, 10% in water [g] | 3.3 | 2.6 | 3.6 | 2.5 | 2.3 | 4.1 | 6.1 |
| Distilled water [g] | 21.0 | 26.0 | 6.0 | 12.0 | 20.5 | 44.0 | 27.3 |
| Total [g] | 176.5 | 181.1 | 161.7 | 165.7 | 175.0 | 200.3 | 185.8 |
| Solids [%] | 34.8 | 37.6 | 36.1 | 38.0 | 35.6 | 30 | 36 |
| Efflux time ISO 5 mm [s] | 39 | 40 | 41 | 38 | 40 | 41 | 40 |
| pH | 8.3 | 8.4 | 8.3 | 8.3 | 8.4 | | 8.4 |
| Baking conditions: | | | | | | | |
| 10 min. RT + 30 min. 140° C. | | | | | | | |
| Pendulum hardness [s] | 232 | 36 | 97 | 191 | 149 | 230 | 200 |
| Dissolvability 1 min. (0-5) | 2144 | 4455 | 4344 | 4344 | 4455 | 2244 | 2444 |
| Film appearance⁽¹⁾ | sat | sat. | sat. | sat. | sat. | sat. | sat. |
| Baking conditions: | | | | | | | |
| 10 min. RT + 30 min. 160° C. | | | | | | | |
| Pendulum hardness [s] | 229 | 39 | 111 | 196 | 163 | 231 | 220 |
| Dissolubility 1 min. (0-5) | 1134 | 4444 | 4344 | 2244 | 4444 | 1134 | 2444 |
| Film appearance⁽¹⁾ | sat. | sat. | sat. | sat. | sat. | sat. | sat. |
| | Dispersion from Example No. | | | | | | |
| | | | | | | | Com- |
| | | | | | | | para- |
| | 15 | 16 | 19 | 20 | 21 | 22 | tive 1 |
| Initial product mass [g] | 150 | 150 | 150 | 150 | 150 | 150 | 150 |
| Additol XW 395, as-supplied form [g] | 1.1 | 1.2 | 1.1 | 0.3⁽⁴⁾ | 0.3⁽⁴⁾ | 0.3⁽⁴⁾ | 0.5 |
| Surfynol 104, 50% in NMP [g] | 1.1 | 1.2 | 1.1 | — | — | — | 0.5 |
| DMEA, 10% in water [g] | 5.1 | 3.1 | 2.2 | 2.8 | 2.3 | 3.3 | — |
| Distilled water [g] | 6.0 | 16.0 | 14.0 | 18.0 | 22.5 | 13.0 | —⁽²⁾ |
| Total [g] | 163.4 | 174.7 | 168.3 | 175.1 | 175.1 | 166.6 | 151.0 |
| Solids [%] | 39 | 40.6 | 34.8 | 35.9 | 34.9 | 34.8 | 23.5 |
| Efflux time ISO 5 mm [s] | 39 | 38 | 36 | 39 | 40 | 38 | 112⁽²⁾ |
| pH | 8.3 | 8.3 | 8.3 | 8.3 | 8.4 | 8.3 | 7.8 |
| Baking conditions: | | | | | | | |
| 10 min. RT + 30 min. 140° C. | | | | | | | |
| Pendulum hardness [s] | 90 | 221 | 98 | 74 | 81 | 102 | ⁽³⁾ |
| Dissolvability 1 min. (0-5) | 4444 | 1444 | 4444 | 4444 | 4444 | 3444 | ⁽³⁾ |
| Film appearance⁽¹⁾ | sat. | sat. | sat. | sat. | sat. | sat. | ⁽³⁾ |
| Baking conditions: | | | | | | | |
| 10 min. RT + 30 min. 160° C. | | | | | | | |
| Pendulum hardness [s] | 104 | 232 | 108 | 84 | 94 | 114 | ⁽³⁾ |
| Dissolubility 1 min. (0-5) | 3444 | 1444 | 3444 | 3444 | 3444 | 3444 | ⁽³⁾ |
| Film appearance⁽¹⁾ | sat. | sat. | sat. | sat. | sat. | sat. | ⁽³⁾ |

⁽¹⁾sat. = satisfactory, no defects;
⁽²⁾adjustment of viscosity not possible, owing to dilatancy;
⁽³⁾measurement not possible, owing to coalescence of the film;
⁽⁴⁾Byk 347 (Byk Chemie, Wesel, DE) was used instead of Additol XW 395

The dispersions prepared by the process according to the invention exhibit the desired high solids content. Additionally, film formation, and the values for the dissolvabilities and pendulum hardnesses of the cured films, are satisfactory. All of these properties are not obtained if the process according to the invention is not used, but instead random polymers are prepared. The defined construction of the polymer structures is therefore critical to these coating compositions. The random processes known from the prior art are unable to attain the advantages described (at least in the combination of the properties described).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing a self-crosslinking polyurethane dispersion which comprises
I) reacting
a1) a polyisocyanate with
a2) at least one hydroxyl component having an average OH functionality of ≧2 and a number average molecular weight of 62 to 2500 g/mol, wherein the hydroxyl component contains at least one acid-functional compound containing at least one isocyanate-reactive group,
to form an NCO-functional or optionally OH-functional prepolymer,
II) then reacting the NCO-functional and optionally OH-functional prepolymer with
a3) a hydroxyl component having an average OH functionality of >1 and
a4) optionally another polyisocyanate component, which may be the same as or different from a1),
to form an OH-functional and NCO-free polyurethane,
III) adding a blocked polyisocyanate either before, during or after the reaction of steps I) and II), or forming a blocked polyisocyanate in situ from a polyisocyanate and a blocking agent after the reaction of step II) has taken place,
IV) neutralizing the acid groups of the resulting composition by adding
a5) a neutralizing agent, and
V) dispersing the resulting composition in water.

2. The process of claim 1 wherein the ratio of the isocyanate groups, including the blocked isocyanate groups, to all isocyanate-reactive groups is 0.8:1 to 1.5:1.

3. The process of claim 1 wherein component a1) and/or a4) comprises hexamethylene diisocyanate (HDI), isophorone diisocyanate (IPDI), diphenylmethane 2,4′- and/or 4,4′-diisocyanate (MDI), tolylene diisocyanate (TDI), 4,4′-diisocyanatodicyclohexylmethane or a polyisocyanate adduct prepared from one of these diisocyanates.

4. The process of claim 1 wherein components a1) and/or a4) comprise a polyisocyanate adduct having uretdione, carbodiimide, isocyanurate, iminooxadiazine dione, biuret, urethane, allophanate, oxadiazinetrione or acylurea groups.

5. The process of claim 1 wherein hydroxyl component a2) has an average OH functionality of 2 to 6 and a number average molecular weight of 62 to 500 g/mol, wherein the hydroxyl component contains at least one acid-functional compound containing at least one isocyanate-reactive group.

6. The process of claim 1 wherein hydroxyl component a2) comprises 1,4-butanediol, 1,3-butanediol, 1,6-hexanediol, 2,2,4-trimethyl-1,3-pentanediol, trimethylolpropane, or a polyester or polyether polyol having a number average molecular weight of ≦2000 g/mol.

7. The process of claim 1 wherein hydroxyl component a2) comprises hydroxypivalic acid, dimethylbutyric acid or dimethylolpropionic acid.

8. The process of one of claims 1 to 7 wherein the polyol component used in a3) comprises
b1) a dihydric to hexahydric alcohol having a number average molecular weight of 62 to 300 g/mol,
b2) a polyol having an OH functionality ≧2 and a number average molecular weight of 300 to 5000 g/mol or
b3) a monofunctional linear polyether having a number average molecular weight of 300 to 3000 g/mol.

9. The process of claim 1 wherein a catalyst is used for the reaction in step I) or step II).

10. The process of claim 1 wherein neutralizing agent a5) comprises triethylamine, dimethylaminoethanol, dimethylcyclohexylamine, triethanolamine, methyldiethanolamine, diisopropanolamine, ethyldiisopropylamine, diisopropyl-cyclohexylamine, N-methylmorpholine, 2-amino-2-methyl-1-propanol or ammonia.

11. A self-crosslinking polyurethane dispersion obtained by a the process claim 1.

12. A coating, adhesive or sealant composition containing the self-crosslinking polyurethane dispersion of claim 11.
